(19) United States
(12) Patent Application Publication
(10) Pub. No.: US 2012/0176676 A1
(43) Pub. Date: Jul. 12, 2012

(54) METHOD OF PRODUCING WIRE-GRID POLARIZER AND WIRE-GRID POLARIZER

(75) Inventor: Jun-ichi Sakamoto, Yokohama-shi (JP)

(73) Assignee: CANON KABUSHIKI KAISHA, Tokyo (JP)

(21) Appl. No.: 13/339,278

(22) Filed: Dec. 28, 2011

(30) Foreign Application Priority Data
Jan. 6, 2011 (JP) 2011-001017

(51) Int. Cl. G02B 5/30; B05D 5/06

(52) U.S. Cl. 359/485.05; 359/492.01; 427/163.1

(57) ABSTRACT

A line-and-space structure having a line portion and a space portion is formed by applying a sol-gel coating on a substrate and transferring a structure of a mold to the coating, and an embedded metal portion is formed by filling the space portion with a molten metal. As the metal to be molten, a metal material having a melting point of not higher than 650° C. and showing, after the solidification, an average extinction coefficient of higher than 5.0 or an average extinction coefficient of higher than 4.5 and an average refractive index of less than 1, at a wavelength range of 400 to 700 nm, is selected to improve optical characteristics.

### BACKGROUND OF THE INVENTION

1. Field of the Invention

The present invention relates to a method of producing a wire-grid polarizer utilizing a line-and-space structure of a metal and relates to a wire-grid polarizer.

2. Description of the Related Art

In wire-grid polarizers, a narrow pitch structure has been realized by progress in manufacturing technology. The pitch of a wire-grid polarizer should be smaller than a half of the wavelength to be used in order to prevent occurrence of diffraction of light at the wavelength. Accordingly, wire-grid polarizers that are usually used at the visible range are required to have a pitch of not greater than 200 nm.

Currently, commercially available wire-grid polarizers are each composed of an aluminum line portion and an air space portion on a substrate and have a structure with a pitch of not greater than 150 nm. Such a narrow pitch structure is produced by, for example, photolithography, dry etching, or vacuum deposition. Apparatuses that are used in these methods are expensive, and thereby manufacturing costs of devices may increase. For example, Japanese Patent Laid-Open No. 2004-77831 discloses a structure and a method of producing the structure, as countermeasures against this increase in cost.

The method disclosed in Japanese Patent Laid-Open No. 2004-77831 uses a damascene process where line-like grooves are formed on a substrate, the grooves are filled with a metal, and the metal protruding from the grooves is removed. In this method, the number of steps is reduced by employing the damascene process, and a high aspect ratio structure of a metal is obtained by the embedding structure. Furthermore, an inexpensive wire-grid polarizer that is excellent in extinction performance and low in device insertion loss is provided by the structure with a high aspect ratio.

However, even in the method using the damascene process, photolithography or dry etching must be performed for forming grooves on a substrate. In addition, vacuum deposition must be performed for filling the grooves with a metal. Consequently, the produced devices become expensive. Furthermore, the wire-grid polarizer having the embedding structure has a problem of that the extinction ratio is lower than that in the case of a structure having an air space portion when compared at the same aspect ratios of the wire portions.

### SUMMARY OF THE INVENTION

The present invention provides a method of producing a wire-grid polarizer that is used at the visible range and has a high extinction ratio inexpensively by not using expensive manufacturing apparatuses, and provides a wire-grid polarizer.

The method of producing a wire-grid polarizer of the present invention includes forming a line-and-space structure having a line portion and a space portion on a substrate, forming an embedded metal portion by filling the space portion of the line-and-space structure with a molten metal and solidifying the metal, and forming a protective layer on the line portion of the line-and-space structure and the embedded metal portion. The metal has a melting point of not higher than 650° C., and the solidified metal has an average extinction coefficient of higher than 5.0 at a wavelength range of 400 to 700 nm.

The wire-grid polarizer can be produced without using expensive process and apparatus, and the produced embedded-type wire-grid polarizer has high extinction ratio and transmittance and is excellent in optical characteristics.

Further features of the present invention will become apparent from the following description of exemplary embodiments with reference to the attached drawings.

### BRIEF DESCRIPTION OF THE DRAWINGS

FIGS. 1A to 1G are process drawings showing a method of producing a wire-grid polarizer according to an embodiment of the present invention.

FIG. 2 is a schematic cross-sectional view illustrating the configuration of a wire-grid polarizer produced by the method shown in FIGS. 1A to 1G.

FIG. 3 is a graph showing spectral transmittance characteristics of a wire-grid polarizer produced in Example 1.

FIG. 4 is a graph showing spectral transmittance characteristics of a wire-grid polarizer produced in Example 2.

FIG. 5 is a graph showing spectral transmittance characteristics of a wire-grid polarizer produced in Example 3.

FIG. 6 is a graph showing spectral transmittance characteristics of a wire-grid polarizer produced in Example 4.

FIG. 7 is a graph showing spectral transmittance characteristics of a wire-grid polarizer produced in Example 5.

FIG. 8 is a graph showing spectral transmittance characteristics of a wire-grid polarizer produced in Example 6.

FIG. 9 is a graph showing spectral transmittance characteristics of a wire-grid polarizer produced in Example 7.

FIG. 10 is a graph showing spectral transmittance characteristics of a wire-grid polarizer produced in Example 8.

FIG. 11 is a graph showing spectral transmittance characteristics of a wire-grid polarizer produced in Comparative Example 2.

FIG. 12 is a graph showing spectral transmittance characteristics of a wire-grid polarizer produced in Comparative Example 3.

FIG. 13 is a graph showing spectral transmittance characteristics of a wire-grid polarizer produced in Comparative Example 4.

FIG. 14 is a graph showing spectral transmittance characteristics of a wire-grid polarizer produced in Comparative Example 5.

### DESCRIPTION OF THE EMBODIMENTS

In the method of producing a wire-grid polarizer according to an embodiment of the present invention, a fine line-and-space structure is formed on a transparent substrate, the space portion of the structure is filled with a molten metal, and a protective film is formed thereon after solidification of the metal. The metal filling the space portion is a metal material having a melting point of not higher than 650° C., and the metal material, after the solidification, has an average extinction coefficient of higher than 5.0 or has an average extinction coefficient of higher than 4.5 and an average refractive index of less than 1, at a wavelength range of 400 to 700 nm. The optical constant of the metal is represented by n−ik, wherein n denotes the refractive index, and k denotes the extinction coefficient. The light incident plane is defined as the face including the normal line perpendicular to the wire grid, the S-polarized light is defined as light of vibrational component parallel to the wire grid, and the P-polarized light is defined as light of vibrational component perpendicular to the wire grid. The behaviors of the S-polarized light and the P-polarized light are switched with each other by turning the wire-grid polarizer by 90°.

Since the melting point of the metal is not higher than 650° C., the space portion can be directly filled with the molten metal without damaging the substrate and the line-and-space structure having a fine scale less than the wavelength. Thus, an inexpensive manufacturing method, such as a reflow method, can be employed. Consequently, a wire-grid polarizer can be produced at a low cost without performing expensive vacuum deposition, photolithography, and dry etching.

In addition, when the metal filling the space portion has an average extinction coefficient of higher than 5.0 or an average extinction coefficient of higher than 4.5 and an average refractive index of less than 1 at the visible range, a wire-grid polarizer having high extinction ratio and transmittance can be realized. Thus, a metal material that satisfies both such melting point and optical constant is selected as the metal.

The metal remaining on the line portion of the line-and-space structure is removed so that the upper surface of the line portion is exposed. If the metal remains on the line portion, it is difficult to realize the desired extinction ratio and transmittance. The metal can be removed by a known method such as lapping or polishing.

Specifically, the metal material is pure-In or an alloy of at least two of Al, Mg, In, Sn, Zn, Ag, and Ge. Al, Ag, and Mg each have a melting point higher than 650° C., but each have a low refractive index (n) and a high extinction coefficient (k) at the visible range. In the production of a wire-grid polarizer, a higher value of k is ideal for obtaining advantageous characteristics. In the case of a k of higher than 4.5 and not higher than 5.0, a lower value of n provides advantageous characteristics. Contrarily, In, Sn, and Zn have low melting points.

The required melting point and the required optical constant can be simultaneously realized by an alloy formed from these metals. It is known that though the melting points of Al and Mg as simple metals are higher than 650° C., the melting point of a eutectic alloy of Al and Mg formed in such a manner that the amount of Mg is about 37.4% by weight based on that of Al is lowered to about 451.5° C. Thus, a eutectic composition can decrease the melting point and can also adjust the optical constant within a desired range. Similarly, also in Al and Ge, a eutectic composition can decrease the melting point such that the melting point of an alloy of Al and Ge in a composition ratio of 90:10 (% by atom) is lowered to about 590° C. In this alloy, a high optical constant, i.e., a high average extinction coefficient k of 5.05 can be realized at the visible range.

Furthermore, in alloys containing Mg, In, and Sn, the surface tensions of molten alloys are low. Accordingly, the fine space portion can be easily filled with an alloy formed from these metals. In particular, Mg shows high effects. Incidentally, pure-In is the only pure metal that can be applied to the method of the present invention.

The refractive index n of the line portion of the line-and-space structure and the refractive index ns of the substrate satisfy a relationship: 1<n<ns. It is ideal that a polarizer produced by filling the space portion of the line-and-space structure with the above-mentioned metal have a refractive index of 1. However, a refractive index of 1 is realized only in a vacuum or a gas and cannot be realized by the space filled with a metal. A wire-grid polarizer having a high extinction ratio can be also produced by lowering the refractive index of the line portion. In the case where the refractive index n of the line portion is higher than the refractive index ns of the substrate, the extinction ratio is decreased due to a decrease in transmittance of P-polarized light and an increase in leakage of S-polarized light.

The line-and-space structure with a fine scale less than the wavelength is formed by nano-imprinting a sol-gel material including a siloxane as a main component. In gelation of the sol-gel material, in general, a certain type of solvent functions as an activator to accelerate formation of microparticles of several nanometers to several tens nanometers. When the sol-gel material is hardened in such a structure of the microparticles, a porous structure is formed, and a fine-hollow structure is maintained. As a result, a line structure having a low refractive index can be produced. The curing temperature for hardening the material while maintaining the porous structure is 150° C. or higher, preferably 200° C. or higher, and the upper limit thereof is 650° C. A temperature higher than this range may cause problems, such as an increase in refractive index or occurrence of absorption of light at the wavelength used. Hardening the sol-gel material under conditions of a temperature of less than 150° C. causes various disadvantages, such as a reduction in hardness, an increase in refractive index, and low solvent resistance of the resulting coating. This temperature varies depending on the sol-gel material and therefore needs to be determined according to the material to be used. The lower limit of the temperature must be lower than the melting point of the embedded metal.

A line-and-space structure with a fine scale less than the wavelength can be produced by utilizing a sol-gel material and nano-imprinting without performing vacuum deposition, photolithography, and dry etching.

The protective layer is heat cured after application of the sol-gel material including siloxane as the main component. By doing so, a low refractive index is achieved by the same mechanism as in the line portion having a low refractive index. By using such a sol-gel material, a wire-grid polarizer can be produced without performing vacuum deposition.

As an ideal optical constant of a metal in the wire-grid polarizer, the metal material has a higher extinction coefficient k. In the case where the average value of the extinction coefficient k (average extinction coefficient) at the visible range is higher than 5.0, a wire-grid polarizer having a high P-polarized light transmittance and a high extinction ratio can be produced, even if the refractive index n is any level that is of a general metal. Preferred examples of such a material include the following binary system alloys: Al—Mg alloys where the content ratio of Al to Mg is 0<Al (% by atom)≦94.5, Al—In alloys where the content ratio of Al to In is 5.9≦Al (% by atom)≦12.5, Al—In alloys where the content ratio of Al to In is 94.2≦Al (% by atom)≦97.5, Al—Zn alloys where the content ratio of Al to Zn is 0<Al (% by atom)≦96.9, Al—Ag alloys where the content ratio of Al to Ag is 50.7≦Al (% by atom)≦93.0, Mg—Zn alloys where the content ratio of Mg to Zn is 74.3≦Mg (% by atom)≦98.0, and Al—Sn alloys where the content ratio of Al to Sn is 7.1≦Al (% by atom)≦96.0. In alloys of ternary or more systems, it is difficult to unambiguously define the composition, but a polarizer having a high extinction ratio to exhibit a high efficiency can be obtained by satisfying the melting point and refractive index conditions according to the present invention.

Contrarily, in the case where the average value of the extinction coefficient k at the visible range is not higher than 4.5, the S-polarized light transmittance increases, resulting in a difficulty in improving the extinction ratio. In the case where the extinction coefficient k is higher than 4.5 and not higher than 5.0, a wire-grid polarizer having a high P-polarized light transmittance and a high extinction ratio can be produced only when the average value of the refractive index n (average refractive index) at the visible range is less than 1. Preferred examples of such a material include the following binary system alloys: Al—Mg alloys where the content ratio of Al to Mg is 0<Al (% by atom)≦94.5, Al—In alloys where the content ratio of Al to In is 0≦Al (% by atom)≦12.5, Al—Zn alloys where the content ratio of Al to Zn is 0<Al (% by atom)≦96.9, Al—Ag alloys where the content ratio of Al to Ag is 35.7≦Al (% by atom)≦93.0, Al—Ge alloys where the content ratio of Al to Ge is 66.8≦Al (% by atom)≦97.0, and Mg—Zn alloys where the content ratio of Mg to Zn is 0≦Mg (% by atom)≦98.0. In particular, in the case where the wire-grid polarizer is produced using an alloy having such optical constants, the reflectance of the S-polarized light increases. Accordingly, the wire-grid polarizer can be also used as a polarization beam splitter that utilizes reflected light. Incidentally, a metal material showing a highest average value of k at the visible range is Al, and the value is 6.65. Consequently, it is difficult that these alloy systems have an extinction coefficient k higher than this value.

As the metal for a wire-grid polarizer that functions at the visible range, Al can realize the highest P-polarized light transmittance and extinction ratio. However, Al has a high melting point of 660° C. and, therefore, cannot be applied to the configuration of the present invention. Accordingly, Al is used as an alloy having a metal composition that reduces the melting point while maintaining the optical constants within feasible ranges, compared with Al.

The pitch P and the space width S of the line-and-space structure satisfy the requirements: 50 nm≦P≦200 nm and 0.2≦S/P≦0.4. In these ranges, a wire-grid polarizer having suitable polarization characteristics is provided. The upper limit value of the pitch is a maximum pitch that does not cause diffraction in a wire-grid polarizer using vertical incident visible light. Diffraction does not occur in the range of pitch not greater than this pitch, and therefore the wire-grid polarizer can be satisfactorily used. In the case where the space for being filled with a molten metal is narrow, it is difficult to fill the space with a metal. Herein, a minimum value of the space width of 10 nm is the lower limit. In the case of a value of S/P exceeding 0.4, the transmittance of P-polarized light highly decreases, which is undesirable for a wire-grid polarizer. Even if the pitch and the space width are outside these ranges, a wire-grid polarizer having satisfactory P-polarized light transmittance and extinction ratio can be realized when the metal filling the space has certain optical constants. Therefore, the pitch and the space width are not limited to the above-mentioned ranges.

The depth D1 of the space portion of the line-and-space structure satisfies the requirement: 90 nm≦D1≦250 nm. Such a high aspect structure can be realized by filling the space having such a depth with a metal, and thereby a wire-grid polarizer having a high extinction ratio is provided. In the case of a depth of shallower than this, though the transmittance of P-polarized light is high, the amount of leakage of S-polarized light is large. Contrarily, in the case of a depth of deeper than this, the amount of leakage of S-polarized light is small, but the transmittance of P-polarized light is low.

The above-described alloys are effective as a metal that can satisfactorily fill the narrow and deep space having a high aspect ratio and can realize a high extinction ratio while maintaining a high transmittance of P-polarized light. Even if the depth of the space portion is outside the above-mentioned range, a wire-grid polarizer having satisfactory P-polarized light transmittance and extinction ratio can be realized when the metal filling the space has certain optical constants. Therefore, the depth is not limited to the above-mentioned range.

The refractive index n2 and the thickness D2 of the protective layer and the central wavelength λ of the light used satisfy the requirements: 1.2≦n2≦1.4 and 0.2λ≦n2˜D2≦0.3λ. In this range, a reflection-preventing effect that is effective at the visible light wavelength range is exhibited to provide a wire-grid polarizer having a high transmittance. In a wire-grid polarizer made of a metal, since the optical constant of the metal approaches an ideal state at the longer wavelength side, the transmittance of P-polarized light and also the extinction ratio are high at the longer wavelength side. Against this, within the above-mentioned ranges of the thickness and the refractive index of the protective film, it is possible to adjust the transmittance of P-polarized light to the maximum at the central wavelength of the visible light range being used. The protective layer also functions as an antioxidant film for the metal filling the space, where the metal is an alloy system that tends to be oxidized.

### EXAMPLES

### Example 1

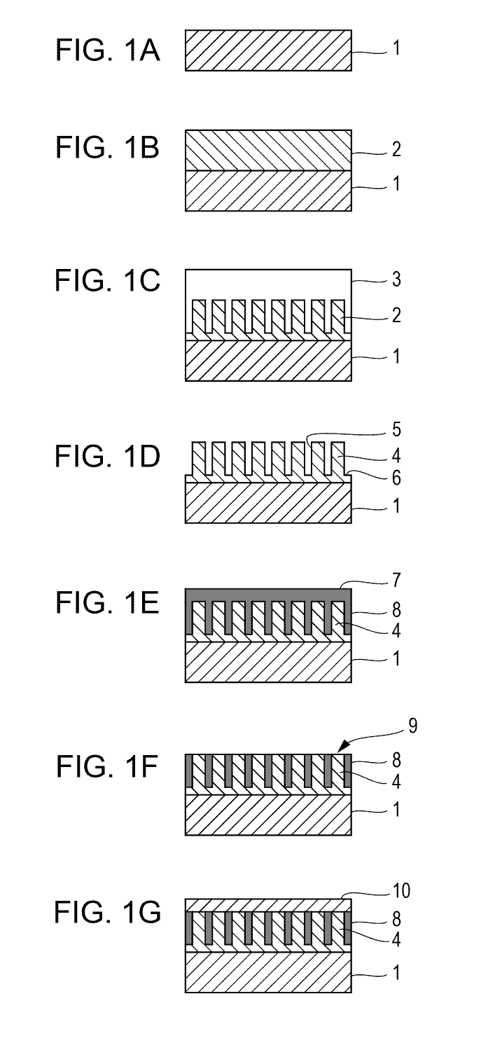

As shown in FIG. 1A, a 35 mm square glass substrate (white plate glass B-270 available from Schott AG) was washed and then dried to prepare a substrate 1. The glass transition point of the substrate is 521° C.

As shown in FIG. 1B, a sol-gel coating 2 was formed on the substrate by applying a sol-gel material containing siloxane as a main component (sol-gel coating material VRS-PRC35N-1K available from RASA Industries, Ltd.) at 1000 rpm for 30 sec with a spin coater.

As shown in FIG. 1C, the substrate 1 provided with the sol-gel coating was placed on a hot plate, a 30 mm square nickel mold 3 having a line-and-space structure on the entire one surface thereof was pressed onto the sol-gel coating, and in this state, the hot plate was heated to 200° C., maintained at the same temperature for 5 min, and then cooled to room temperature. The nickel mold 3 has a rectangular shape with a line width of 31 nm, a space width of 109 nm, and a space depth of 240 nm.

As shown in FIG. 1D, the mold 3 was detached, followed by curing at 500° C. for 30 min to obtain a line-and-space-transferred substrate having a line-and-space structure where a line part 4 and a space part 5 are alternately and repeatedly arranged. The obtained line-and-space structure had a line width of 98 nm, a space width of 42 nm, and a space depth of 216 nm. The difference between the scales of the mold 3 and the line-and-space structure was caused by the shrinkage due to thermohardening of the sol-gel material. Therefore, the release characteristics of the mold 3 were good. The remaining coating part 6 had a thickness of 30 nm. Similarly, a sol-gel coating was applied to another substrate and was cured at 500° C. for 30 min to obtain a coating. The refractive index of the coating was 1.27.

As shown in FIG. 1E, the line-and-space transferred substrate obtained in the step shown in FIG. 1D was placed on a hot plate in an Ar-purged glove box. On this occasion, the line-and-space transferred substrate and the hot plate were held by vacuum adsorption through a 32 mm square copper spacer plate with a thickness of 2 mm. One gram of a lump of the metal was disposed on the line-and-space structure. The composition of a lump of the metal was an alloy composed of 65.0% by weight of Al and 35.0% by weight of Mg and having a melting point of 451.5° C. The hot plate was heated to 500° C. and was maintained at the same temperature. On this occasion, a quartz substrate provided with a BN coating and then flattened was separately prepared in advance and was similarly heated at 500° C. The thus-prepared quartz substrate was pressed onto the molten metal on the line-and-space transferred substrate and was moved in a reciprocating motion in the direction parallel to the line ten times to fill the space portion with the metal. Then, the metal was cooled to room temperature to obtain a structure having a metal layer 7 of excess metal remained on the upper area and an embedded metal portion 8 formed in the space parts 5 between the line parts 4.

Similarly, a coating of the same alloy filling the space portion was formed on a quartz substrate by a reflow method, and the optical constants thereof were measured from the back surface with a commercially available meter (ellipsometer available from J. A. Woollam Co.). The refractive index n and the extinction coefficient k at a wavelength range of 400 to 700 nm were 0.335≦n≦1.194 (average refractive index: 0.700) and 3.84≦k≦6.58 (average extinction coefficient: 5.28), respectively. The average value of k was higher than 5, which was within the condition range of the present invention.

As shown in FIG. 1F, the resulting substrate was subjected to lapping with a lapping material #4000 (lapping sheet available from Sumitomo 3M Limited) to expose the top part 9 of the line structure.

As shown in FIG. 1G, a protective layer 10 was formed on the line parts 4 and the embedded metal parts 8 by applying a sol-gel material used in the step of FIG. 1B onto the substrate obtained in the step of FIG. 1F at 5000 rpm for 30 sec with a spin coater. As in the step shown in FIG. 1D, a sol-gel coating was applied to another substrate and was cured at 350° C. for 5 min to obtain a coating having a refractive index of 1.25 and a thickness of 70 nm.

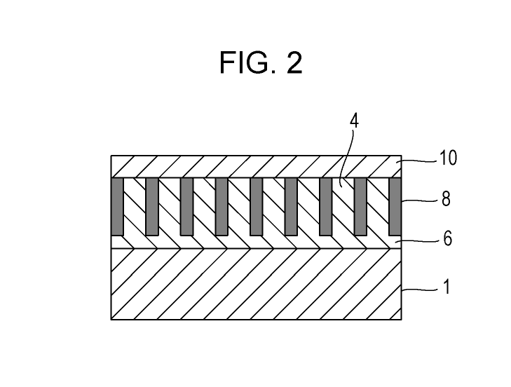

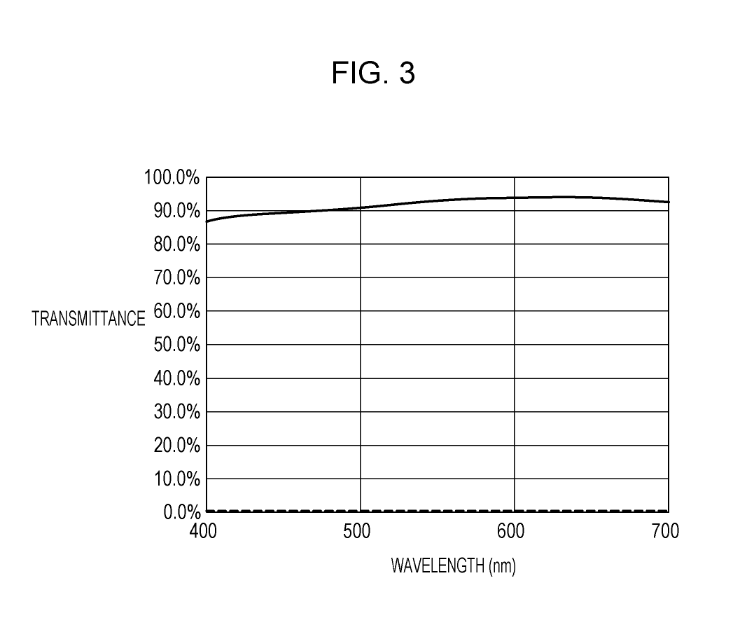

FIG. 2 shows a cross-section of the resulting wire-grid polarizer having the substrate 1, the remaining coating part 6, the line parts 4, the embedded metal parts 8, and protective layer 10. The spectral transmittance characteristics of this wire-grid polarizer are shown in FIG. 3. The spectral transmittance was measured with a commercially available spectrophotometer (self-recording spectrophotometer U-4000 available from Hitachi Ltd.). The curve, shown by a solid line, indicates the transmittance of P-polarized light, and the curve, shown by a broken line, indicates the transmittance of S-polarized light. The average transmittances of P-polarized light and S-polarized light at the visible range were 91.8% and 0.06%, respectively, and the average extinction ratio at the visible range was 32.9 db. Thus, a wire-grid polarizer having excellent polarization characteristics was obtained. In particular, the wire-grid polarizer had an average transmittance of P-polarized light of 90% or more and an extinction ratio of 30 db or more and was therefore excellent one.

Thus, a high-quality and inexpensive wire-grid polarizer was able to be produced without performing, for example, expensive photolithography, dry etching, and vacuum deposition.

### Example 2

In the step shown in FIG. 1A, a glass substrate (optical glass L-PHL1) was used as the substrate 1. This glass substrate had a glass transition point of 347° C. In the step shown in FIG. 1B, a sol-gel coating 2 was formed on the substrate by applying a sol-gel material (sol-gel coating material VRS-PRC35N-1K available from RASA Industries, Ltd.) at 1500 rpm for 30 sec with a spin coater.

In the step shown in FIG. 1C, a nickel mold 3 having a line width of 46 nm, a space width of 94 nm, and a space depth of 200 nm was used.

In the step shown in FIG. 1D, the mold 3 was detached, and curing was performed at 300° C. for 30 min to obtain a line-and-space transferred substrate having a structure where a line part 4 and a space part 5 are alternately and repeatedly arranged. The obtained line-and-space structure had a line width of 85 nm, a space width of 55 nm, and a space depth of 180 nm. The remaining coating part 6 had a thickness of 10 nm. Similarly, a sol-gel coating was applied to another substrate and was cured at 300° C. for 30 min to obtain a coating. The refractive index of the coating was 1.25.

In the step shown in FIG. 1E, the embedded metal parts 8 were formed by pure-In. A lump of In started to melt at 156° C. The space parts 5 were filled with the metal at a hot plate temperature of 250° C. The optical constants of the embedded pure-In were measured as in Example 1. The refractive index n and the extinction coefficient k at a wavelength range of 400 to 700 nm were 0.479≦n≦1.01 (average refractive index: 0.764) and 3.89≦k≦5.83 (average extinction coefficient: 4.90), respectively.

In the step shown in FIG. 1G, a protective layer 10 was formed by application with a spin coater at 5000 rpm for 30 sec and curing at 150° C. for 5 min. The protective layer 10 had a refractive index of 1.44 and a thickness of 70 nm. Other steps were conducted as in Example 1.

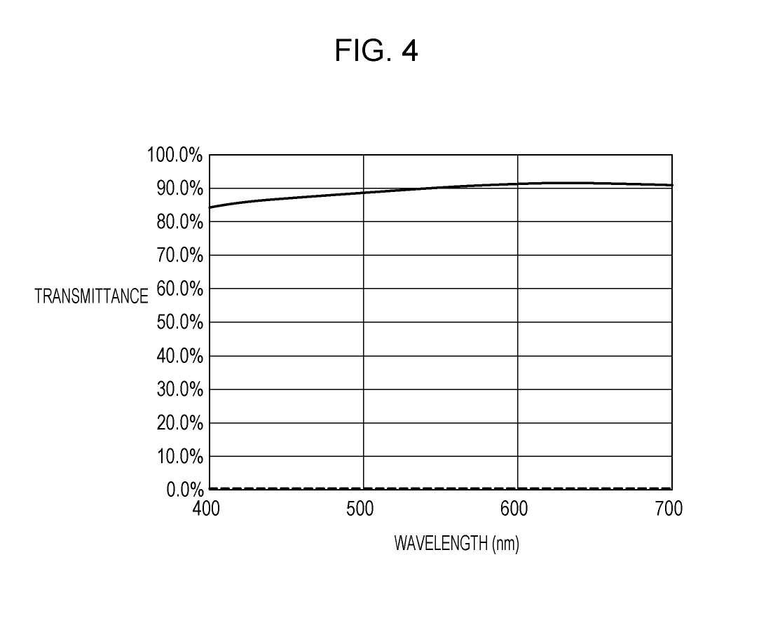

The spectral transmittance characteristics of the wire-grid polarizer prepared in this Example are shown in FIG. 4. The resulting wire-grid polarizer exhibited an average P-polarized light transmittance of 89.2%, an average S-polarized light transmittance of 0.19%, and an average extinction ratio of 27.0 db, at the visible range.

### Example 3

In this example, a quartz substrate was used as the substrate 1 in Example 1. The nickel mold 3 used in the step in FIG. 1C had a line width of 31 nm, a space width of 109 nm, and a space depth of 222 nm.

In the step shown in FIG. 1D, the mold 3 was detached, and curing was performed in a nitrogen atmosphere at 650° C. for 30 min to obtain a line-and-space transferred substrate having a structure where a line part 4 and a space part 5 are alternately and repeatedly arranged. The obtained line-and-space structure had a line width of 94 nm, a space width of 46 nm, and a space depth of 200 nm. The remaining coating part 6 had a thickness of 25 nm. Similarly, a sol-gel coating was applied to another substrate and was cured at 650° C. for 30 min to obtain a coating. The refractive index of the coating was 1.31.

In the step shown in FIG. 1E, embedded metal parts 8 of Al (11% by weight)+In (89% by weight) were formed. A lump of the metal started to melt at 635° C. The space parts 5 were filled with the metal at a hot plate temperature of 700° C. The optical constants of the embedded metal were measured as in Example 1. The refractive index n and the extinction coefficient k at a wavelength range of 400 to 700 nm were 0.473≦n≦1.07 (average refractive index: 0.780) and 3.90≦k≦5.91 (average extinction coefficient: 4.95), respectively. Other steps were conducted as in Example 1.

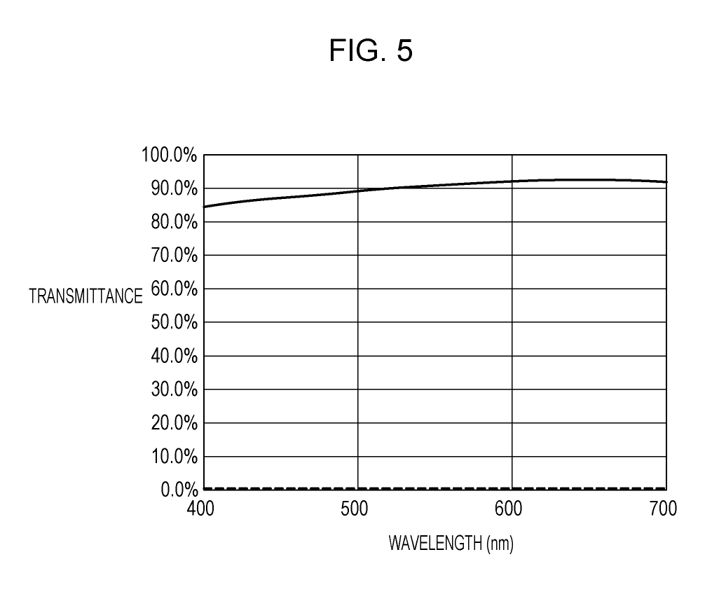

The spectral transmittance characteristics of the wire-grid polarizer prepared in this Example are shown in FIG. 5. The resulting wire-grid polarizer exhibited an average P-polarized light transmittance of 89.9%, an average S-polarized light transmittance of 0.16%, and an average extinction ratio of 27.8 db, at the visible range.

### Example 4

In this Example, a white plate was used as the substrate 1 in Example 3. In the step shown in FIG. 1E, embedded metal parts 8 of Al (11.3% by atom)+Zn (88.7% by atom) were formed. A lump of the metal started to melt at 382° C. The space parts 5 were filled with the metal at a hot plate temperature of 450° C. The optical constants of the embedded metal were measured as in Example 1. The refractive index n and the extinction coefficient k at a wavelength range of 400 to 700 nm were 0.558≦n≦4.21 (average refractive index: 2.06) and 4.40≦k≦5.90 (average extinction coefficient: 5.31), respectively. The metal had a refractive index n not less than 1, but had an extinction coefficient k higher than 5 and thereby realized good polarization characteristics. Other steps were conducted as in Example 3.

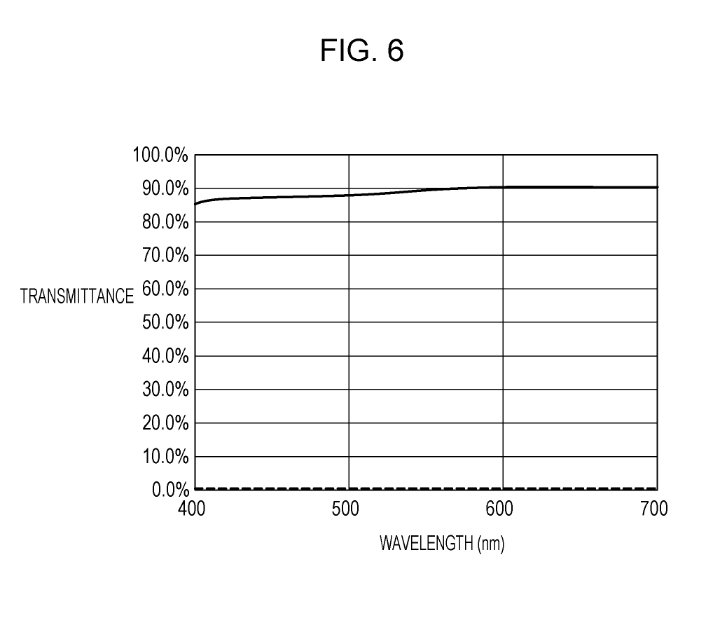

The spectral transmittance characteristics of the wire-grid polarizer prepared in this Example are shown in FIG. 6. The resulting wire-grid polarizer exhibited an average P-polarized light transmittance of 88.7%, an average S-polarized light transmittance of 0.03%, and an average extinction ratio of 34.3 db, at the visible range. In particular, the wire-grid polarizer had an extinction ratio of not less than 30 db and was therefore good one.

### Example 5

In this Example, in the step shown in FIG. 1E, embedded metal parts 8 of Al (32.0% by atom)+Zn (68.0% by atom) were formed. A lump of the metal started to melt at 450° C. The space parts 5 were filled with the metal at a hot plate temperature of 550° C. The optical constants of the embedded metal were measured as in Example 1. The refractive index n and the extinction coefficient k at a wavelength range of 400 to 700 nm were 0.526≦n≦3.59 (average refractive index: 1.79) and 4.31≦k≦6.00 (average extinction coefficient: 5.34), respectively. Other steps were conducted as in Example 4.

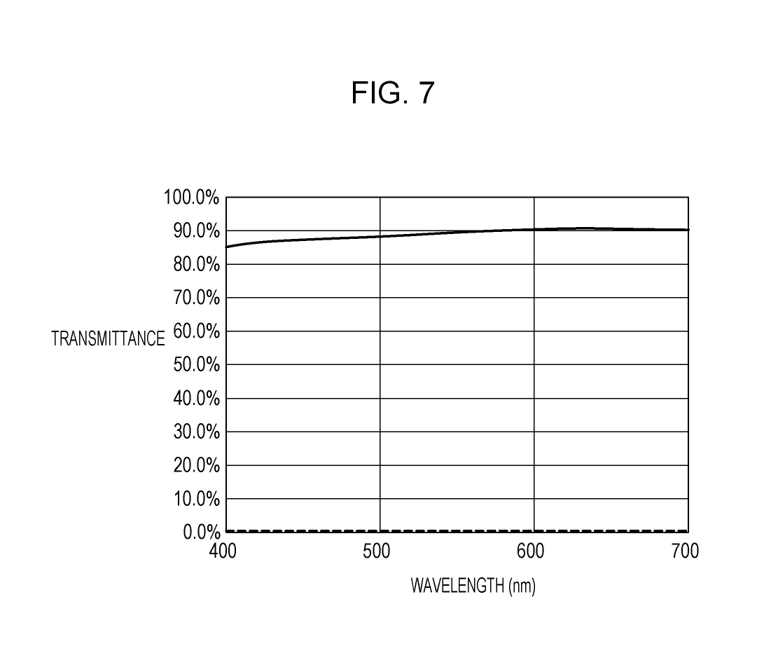

The spectral transmittance characteristics of the wire-grid polarizer prepared in this Example are shown in FIG. 7. The resulting wire-grid polarizer exhibited an average P-polarized light transmittance of 89.0%, an average S-polarized light transmittance of 0.04%, and an average extinction ratio of 34.1 db, at the visible range. In particular, the wire-grid polarizer had an extinction ratio of not less than 30 db and was therefore good one.

### Example 6

In this Example, a base material (S-BSL7) was used as the substrate 1 in Example 4. In the step shown in FIG. 1E, embedded metal parts 8 of Mg (87.3% by atom)+Zn (12.7% by atom) were formed. A lump of the metal started to melt at 480° C. The space parts 5 were filled with the metal at a hot plate temperature of 550° C. The optical constants of the embedded metal were measured as in Example 1. The refractive index n and the extinction coefficient k at a wavelength range of 400 to 700 nm were 0.187≦n≦0.605 (average refractive index: 0.363) and 3.56≦k≦6.55 (average extinction coefficient: 5.04), respectively. Other steps were conducted as in Example 4.

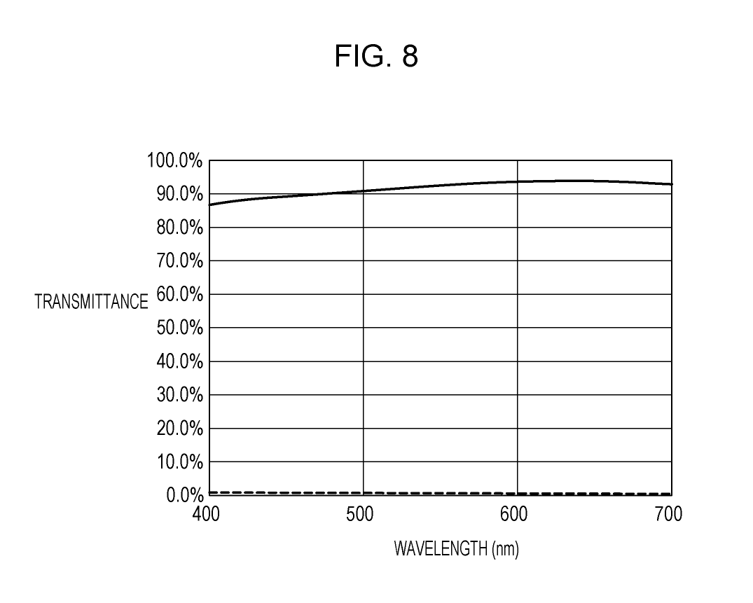

The spectral transmittance characteristics of the wire-grid polarizer prepared in this Example are shown in FIG. 8. The resulting wire-grid polarizer exhibited an average P-polarized light transmittance of 91.8%, an average S-polarized light transmittance of 0.30%, and an average extinction ratio of 27.5 db, at the visible range. In particular, the wire-grid polarizer had an average P-polarized light transmittance of not less than 90% and was therefore good one.

### Example 7

In this Example, in the step shown in FIG. 1E, embedded metal parts 8 of Mg (90.0% by atom)+Al (9.0% by atom)+Zn (1.0% by atom) were formed. A lump of the metal started to melt at 600° C. The space parts 5 were filled with the metal at a hot plate temperature of 650° C. The optical constants of the embedded metal were measured as in Example 1. The refractive index n and the extinction coefficient k at a wavelength range of 400 to 700 nm were 0.202≦n≦0.634 (average refractive index: 0.385) and 3.58≦k≦6.57 (average extinction coefficient: 5.07), respectively. Other steps were conducted as in Example 3.

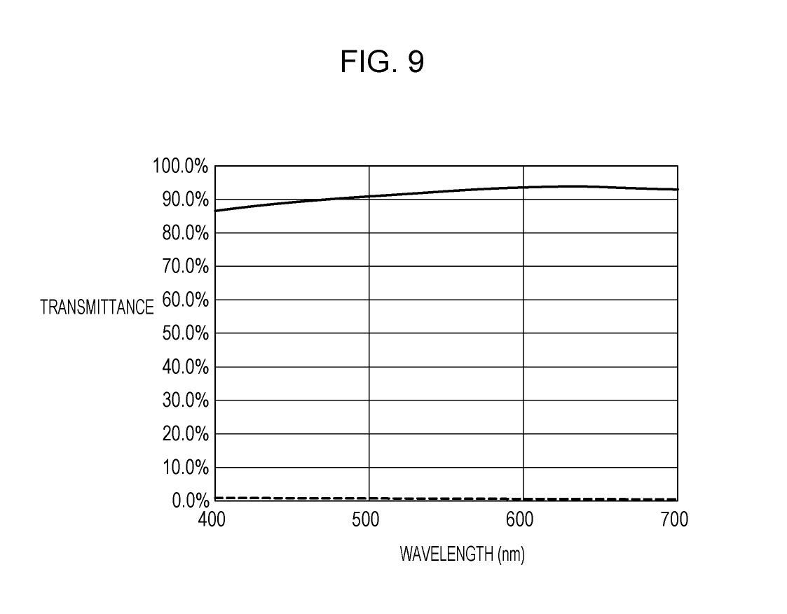

The spectral transmittance characteristics of the wire-grid polarizer prepared in this Example are shown in FIG. 9. The resulting wire-grid polarizer exhibited an average P-polarized light transmittance of 91.8%, an average S-polarized light transmittance of 0.26%, and an average extinction ratio of 27.9 db, at the visible range. In particular, the wire-grid polarizer had an average P-polarized light transmittance of not less than 90% and was therefore good one.

### Example 8

In the step shown in FIG. 1E, embedded metal parts 8 of Al (50.0% by atom)+Ag (15.0% by atom)+Sn (35.0% by atom) were formed as in Example 6. A lump of the metal started to melt at 450° C. The space parts 5 were filled with the metal at a hot plate temperature of 550° C. The optical constants of the embedded metal were measured as in Example 1. The refractive index n and the extinction coefficient k at a wavelength range of 400 to 700 nm were 0.589≦n≦1.53 (average refractive index: 0.995) and 3.51≦k≦6.13 (average extinction coefficient: 4.91), respectively.

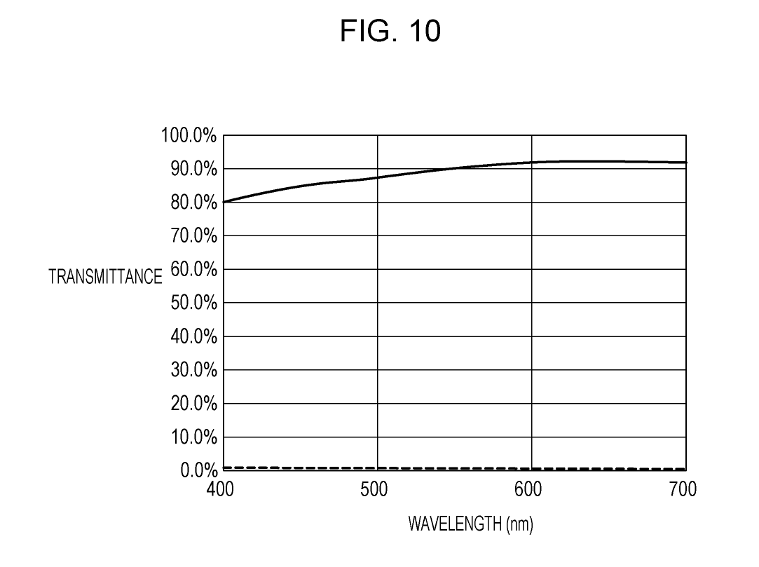

The spectral transmittance characteristics of the wire-grid polarizer prepared in this Example are shown in FIG. 10. The resulting wire-grid polarizer exhibited an average P-polarized light transmittance of 88.7%, an average S-polarized light transmittance of 0.26%, and an average extinction ratio of 26.9 db, at the visible range.

### Example 9

In the step shown in FIG. 1E, embedded metal parts 8 of Al (90% by atom)+Ge (10% by atom) were formed as in Example 3. A lump of the metal started to melt at 590° C. The space parts 5 were filled with the metal at a hot plate temperature of 650° C. The optical constants of the embedded metal were measured as in Example 1. The refractive index n and the extinction coefficient k at a wavelength range of 400 to 700 nm were 0.793≦n≦1.92 (average refractive index: 1.31) and 3.82≦k≦5.96 (average extinction coefficient: 5.04), respectively.

The spectral transmittance characteristics of the wire-grid polarizer prepared in this Example are shown in FIG. 15. The resulting wire-grid polarizer exhibited an average P-polarized light transmittance of 93.6%, an average S-polarized light transmittance of 0.001%, and an average extinction ratio of 51.3 db, at the visible range.

### Comparative Example 1

In the step shown in FIG. 1E, embedded metal parts of pure-Al were formed as in Example 1. One gram of a lump of Al was disposed on the line-and-space structure, followed by heating on a hot plate. The glass substrate started to soften at a hot-plate-indicating temperature of 560° C., and deformation of the surface was visually observed along the glass adsorption grooves. Therefore, the producing process was stopped without melting the Al.

### Comparative Example 2

In the step shown in FIG. 1E, embedded metal parts of Al (41.0% by atom)+Sn (59.0% by atom) were formed as in Example 7. A lump of the metal started to melt at 450° C. The space parts were filled with the metal at a hot plate temperature of 550° C. The optical constants of the embedded metal were measured as in Example 1. The refractive index n and the extinction coefficient k at a wavelength range of 400 to 700 nm were 0.664≦n≦1.27 (average refractive index: 0.929) and 2.83 k 5.50 (average extinction coefficient: 4.23), respectively. Other steps were conducted as in Example 7.

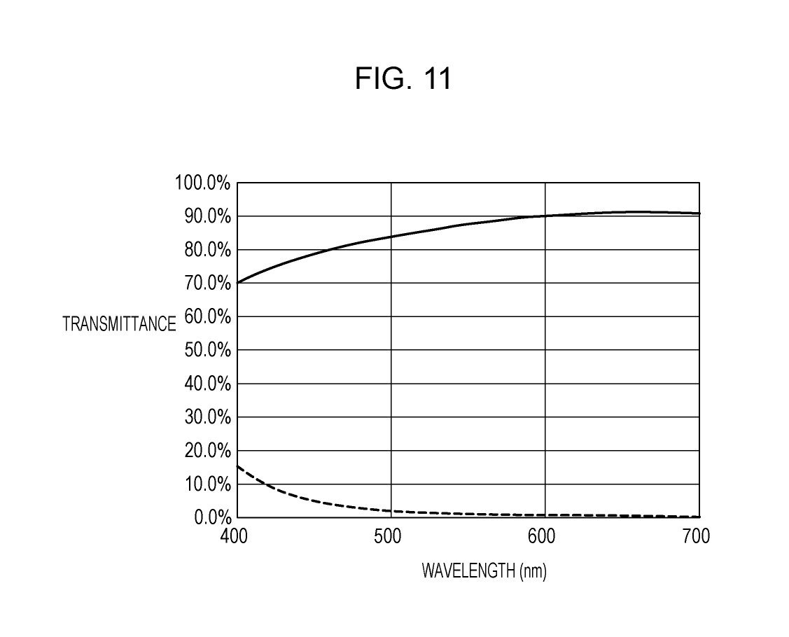

The spectral transmittance characteristics of the wire-grid polarizer prepared in this Comparative Example are shown in FIG. 11. The resulting wire-grid polarizer exhibited an average P-polarized light transmittance of 85.6%, an average S-polarized light transmittance of 2.86%, and an average extinction ratio of 17.8 db, at the visible range. Thus, the average P-polarized light transmittance was low and the transmitted leakage S-polarized light was high, resulting in a wire-grid polarizer having a low extinction ratio.

### Comparative Example 3

The same method as in Example 1 was conducted using a nickel mold 3 having a line width of 31 nm, a space width of 109 nm, and a space depth of 222 nm in the step shown in FIG. 1C. In the step shown in FIG. 1D, the mold 3 was detached, and curing was performed in a nitrogen atmosphere at 650° C. for 30 min to obtain a line-and-space transferred substrate having a structure where a line part 4 and a space part 5 are alternately and repeatedly arranged. The obtained line-and-space structure had a line width of 94 nm, a space width of 46 nm, and a space depth of 200 nm. The remaining coating part 6 had a thickness of 25 nm. Similarly, a sol-gel coating was applied to another substrate and was cured at 650° C. for 30 min to obtain a coating. The refractive index of the coating was 1.31.

In the step shown in FIG. 1E, embedded metal parts of Al (16.0% by atom)+Sn (84.0% by atom) were formed. A lump of the metal started to melt at 443° C. The space parts were filled with the metal at a hot plate temperature of 550° C. The optical constants of the embedded metal were measured as in Example 1. The refractive index n and the extinction coefficient k at a wavelength range of 400 to 700 nm were 0.912≦n≦1.98 (average refractive index: 1.39) and 3.54≦k≦6.24 (average extinction coefficient: 4.96), respectively. Other steps were conducted as in Example 1.

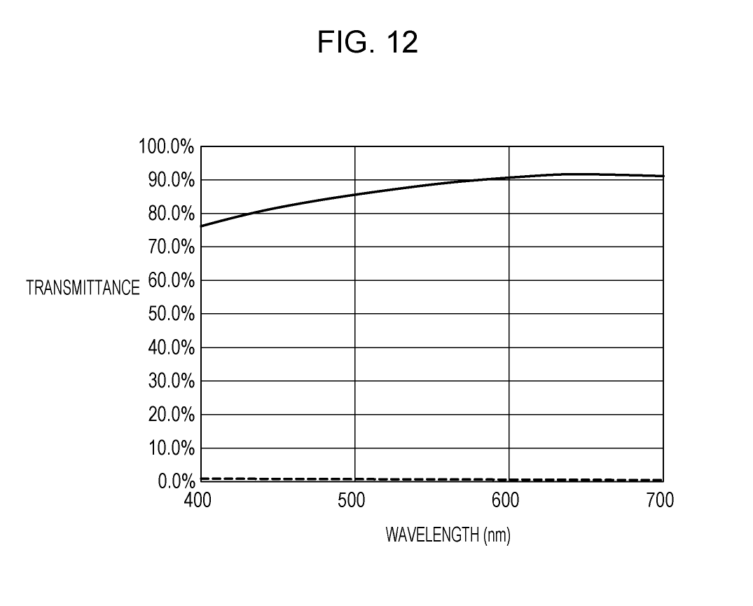

The spectral transmittance characteristics of the wire-grid polarizer prepared in this Comparative Example are shown in FIG. 12. The resulting wire-grid polarizer exhibited an average P-polarized light transmittance of 87.3%, an average S-polarized light transmittance of 0.19%, and an average extinction ratio of 28.3 db, at the visible range. In particular, the P-polarized light transmittance decreased at the shorter wavelength side.

### Comparative Example 4

In the step shown in FIG. 1E, embedded metal parts of Zn (16.0% by atom)+Sn (84.0% by atom) were formed by the same method as in Example 2. A lump of the metal started to melt at 198° C. The space parts were filled with the metal at a hot plate temperature of 300° C. The optical constants of the embedded metal were measured as in Example 1. The refractive index n and the extinction coefficient k at a wavelength range of 400 to 700 nm were 0.912≦n≦1.97 (average refractive index: 1.39) and 3.54≦k≦6.24 (average extinction coefficient: 4.96), respectively. Other steps were conducted as in Example 2.

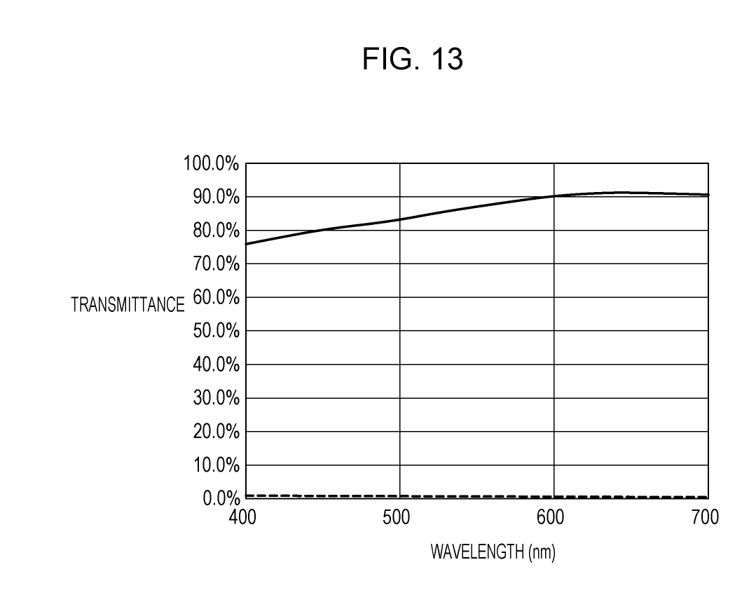

The spectral transmittance characteristics of the wire-grid polarizer prepared in this Comparative Example are shown in FIG. 13. The resulting wire-grid polarizer exhibited an average P-polarized light transmittance of 86.0%, an average S-polarized light transmittance of 0.16%, and an average extinction ratio of 28.5 db, at the visible range. In particular, the P-polarized light transmittance decreased at the shorter wavelength side.

### Comparative Example 5

In the step shown in FIG. 1B, a sol-gel coating was formed by the same method as in Example 1 by applying a sol-gel material (sol-gel coating material VR-153-1K available from RASA Industries, Ltd.) at 1000 rpm for 30 sec with a spin coater. The refractive index of this material was 1.55.

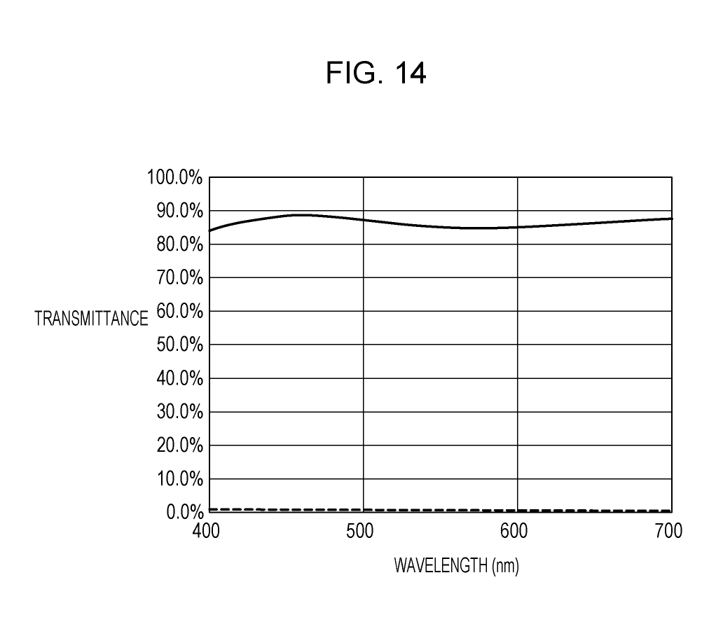

The spectral transmittance characteristics of the wire-grid polarizer prepared in this Comparative Example are shown in FIG. 14. The resulting wire-grid polarizer exhibited an average P-polarized light transmittance of 86.4%, an average S-polarized light transmittance of 0.17%, and an average extinction ratio of 29.4 db, at the visible range. The characteristics were acceptable to be used as a polarizer, but all the P-polarized light transmittance, the amount of leaked S-polarized light, and the extinction ratio were inferior to those in Example 1.

The wire-grid polarizer of the present invention can be satisfactorily used as a polarizer of, for example, a liquid crystal projector or a liquid crystal display and also can be used as a polarization beam splitter for separating incident light into different linear polarized light components.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-001017 filed Jan. 6, 2011, which is hereby incorporated by reference herein in its entirety.

What is claimed is:

1. A method of producing a wire-grid polarizer comprising:
forming a line-and-space structure having a line portion and a space portion on a substrate;
forming an embedded metal portion by filling the space portion of the line-and-space structure with a molten metal and solidifying the metal; and
forming a protective layer on the line portion of the line-and-space structure and the embedded metal portion,
wherein the metal has a melting point of not higher than 650° C., and the solidified metal has an average extinction coefficient of higher than 5.0 at a wavelength range of 400 to 700 nm.

2. The method of producing a wire-grid polarizer according to claim 1, wherein the metal is pure-In or an alloy of at least two of Al, Mg, In, Sn, Zn, Ag, and Ge.

3. The method of producing a wire-grid polarizer according to claim 1, wherein the line portion of the line-and-space structure and the substrate have refractive indices n and ns, respectively, that satisfy a relationship: 1<n<ns.

4. The method of producing a wire-grid polarizer according to claim 1, wherein the line-and-space structure is formed by nano-imprinting a sol-gel material.

5. The method of producing a wire-grid polarizer according to claim 1, wherein the protective layer is formed by application of a sol-gel material and solidification of the material.

6. A method of producing a wire-grid polarizer comprising:
forming a line-and-space structure having a line portion and a space portion on a substrate;
forming an embedded metal portion by filling the space portion of the line-and-space structure with a molten metal and solidifying the metal; and
forming a protective layer on the line portion of the line-and-space structure and the embedded metal portion,
wherein the metal has a melting point of not higher than 650° C., and the solidified metal has an average extinction coefficient of higher than 4.5 and an average refractive index of less than 1 at a wavelength range of 400 to 700 nm.

7. A wire-grid polarizer comprising:
a line-and-space structure having a line portion and a space portion disposed on a substrate;
an embedded metal portion of a metal filling the space portion of the line-and-space structure; and
a protective layer disposed on the line portion of the line-and-space structure and the embedded metal portion,
wherein the metal has a melting point of not higher than 650° C., and the solidified metal has an average extinction coefficient of higher than 5.0 at a wavelength range of 400 to 700 nm.

8. The wire-grid polarizer according to claim 7, wherein the metal is pure-In or an alloy of at least two of Al, Mg, In, Sn, Zn, Ag, and Ge.

9. The wire-grid polarizer according to claim 7, wherein the line portion of the line-and-space structure and the substrate have refractive indices n and ns, respectively, that satisfy a relationship: 1<n<ns.

10. The wire-grid polarizer according to claim 7, wherein the line-and-space structure is formed by nano-imprinting a sol-gel material.

11. The wire-grid polarizer according to claim 7, wherein the protective layer is formed by application of a sol-gel material and solidification of the material.

12. A wire-grid polarizer comprising:
a line-and-space structure having a line portion and a space portion disposed on a substrate;
an embedded metal portion of a metal filling the space portion of the line-and-space structure; and
a protective layer disposed on the line portion of the line-and-space structure and the embedded metal portion,
wherein the metal has a melting point of not higher than 650° C., and the solidified metal has an average extinction coefficient of higher than 4.5 and an average refractive index of less than 1 at a wavelength range of 400 to 700 nm.
